(19) United States
(12) Patent Application Publication
(10) Pub. No.: US 2005/0103755 A1
(43) Pub. Date: May 19, 2005

(54) Hand-held laser welding wand reflection shield

(76) Inventors: Martin C. Baker, Budd Lake, NJ (US); Federico Renteria, Greenville, SC (US); Thomas M. Hughes, Greer, SC (US); Clyde R. Taylor, Laurens, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/713,178

(22) Filed: Nov. 13, 2003

(51) Int. Cl. B23K 26/20; B23K 26/14

(52) U.S. Cl. 219/121.63; 219/121.84

(57) ABSTRACT

A hand-held laser welding wand includes a reflection shield that reflects laser light that is reflected off a work piece surface away from the hand of a user of the hand-held laser welding wand. The shield also reflects the thermal radiation transmitted from the work piece toward the wand during the weld process. This will help guard against a user of the wand absorbing laser light that may be reflected off the work piece, as well as significantly reduce any heat that might be transferred to the wand as a result of the reflected laser light.

### CROSS-REFERENCE TO RELATED APPLICATIONS

This application is related to U.S. patent application Ser. No. 10/460,008, filed Jun. 12, 2003, which is a divisional of U.S. patent application Ser. No. 10/071,025, filed Feb. 8, 2002, which issued as U.S. Pat. No. 6,593,540, on Jul. 15, 2003.

### FIELD OF THE INVENTION

The present invention relates to laser welding and, more particularly, to a hand-held laser welding wand that includes a reflection shield.

### BACKGROUND OF THE INVENTION

Many components in a jet engine are designed and manufactured to withstand relatively high temperatures. Included among these components are the turbine blades, vanes, and nozzles that make up the turbine engine section of the jet engine. In many instances, various types welding processes are used during the manufacture of the components, and to repair the components following a period of usage. Moreover, various types of welding technologies and techniques may be used to implement these various welding processes. However, one particular type of welding technology that has found increased usage in recent years is laser welding technology.

Laser welding technology uses a high power laser to manufacture parts, components, subassemblies, and assemblies, and to repair or dimensionally restore worn or damaged parts, components, subassemblies, and assemblies. In general, when a laser welding process is employed, laser light of sufficient intensity to form a melt pool is directed onto the surface of a metal work piece, while a filler material, such as powder, wire, or rod, is introduced into the melt pool. Until recently, such laser welding processes have been implemented using laser welding machines. These machines are relatively large, and are configured to run along one or more preprogrammed paths.

Although programmable laser welding machines, such as that described above, are generally reliable, these machines do suffer certain drawbacks. For example, a user may not be able to manipulate the laser light or work piece, as may be needed, during the welding process. This can be problematic for weld processes that involve the repair or manufacture of parts having extensive curvature and/or irregular or random distributed defect areas. Thus, in order to repair or manufacture parts of this type, the Assignee of the present application developed a portable, hand-held laser welding wand. Among other things, this hand-held laser welding wand allows independent and manual manipulation of the laser light, the filler material, and/or the work piece during the welding process. An exemplary embodiment of the hand-held laser welding wand is disclosed in U.S. Pat. No. 6,593,540, which is entitled “Hand Held Powder-Fed Laser Fusion Welding Torch,” and the entirety of which is hereby incorporated by reference.

The hand-held laser welding wand, such as the one described above, provides the capability to perform manual 3-D adaptive laser welding on components. However, because an operator holds the wand while welding a work piece, the operator's hand may be in close proximity to the work piece. When the laser light impinges on the work piece, some of the laser light may be reflected back toward the operator's hand. Moreover, some thermal radiation that is generated during the weld process may be transmitted back toward the wand and/or the operator's hand. Although the operator may likely wear gloves or other hand covering that is substantially impervious to laser light, it would be desirable to provide an additional barrier between the operator's hand and the reflected laser light.

Hence, there is a need for a shield that will reflect laser light that is reflected off a work piece surface away from the hand of a hand-held laser welding wand user. There is also a need for a shield that will reflect the thermal radiation transmitted from the work piece toward the wand during the weld process. The present invention addresses one or more of these needs.

### SUMMARY OF THE INVENTION

The present invention provides a shield for a hand-held laser welding want that will reflect laser light reflected off a work piece surface away from the hand of a user of the hand-held laser welding wand, and that will reflect the thermal radiation transmitted from the work piece toward the wand during the weld process.

In one embodiment, and by way of example only, a hand-held laser fusion welding assembly for treating a workpiece includes a main body, a nozzle, and a laser reflection shield. The main body is dimensioned to be grasped by a hand and has at least a first end and a second end. The main body first end is adapted to couple to at least a laser delivery system. The nozzle is coupled to the main body second end, and has an aperture through which laser light from the laser delivery system may pass. The laser reflection shield is coupled to, and at least partially surrounds, either the nozzle or the main body, and is constructed at least partially of a material that reflects at least a portion of the laser light that passes through the nozzle aperture and is reflected by the workpiece.

In another exemplary embodiment, a laser reflection shield for reflecting laser light includes a clamp and a shield plate. The clamp is adapted to mount on a hand-held laser welding wand, and has at least a front side and a back side. The shield plate is coupled to clamp front side, and is constructed at least partially of a material that reflects at least a portion of the laser light.

Other independent features and advantages of the preferred welding wand and reflection shield will become apparent from the following detailed description, taken in conjunction with the accompanying drawings which illustrate, by way of example, the principles of the invention.

### BRIEF DESCRIPTION OF THE DRAWINGS

FIG. 1 is a side view of an exemplary hand-held laser welding wand;

FIG. 2 is a perspective exploded view of the hand-held laser welding wand of FIGS. 1;

FIGS. 3-5 are partial cut-away perspective views of the hand-held laser welding wand shown in FIGS. 1 and 2;

FIG. 6 is a perspective exploded view of a laser reflection shield according to an exemplary embodiment of the present invention that may be used with the laser welding wand shown in FIGS. 1-5;

FIG. 7 is a front view of a portion of the laser reflection shield of FIG. 6;

FIG. 8 is a cross section view of a portion of the laser reflection shield taken along line 8-8 of FIG. 7; and

FIGS. 9 and 10 are front and perspective views, respectively of an alternative laser reflection shield that may be used with the laser welding wand shown in FIGS. 1-5.

### DETAILED DESCRIPTION OF A PREFERRED EMBODIMENT

Before proceeding with the detailed description, it should be appreciated that the following detailed description is merely exemplary in nature and is not intended to limit the invention or the application and uses of the invention. Furthermore, there is no intention to be bound by any theory presented in the preceding background or the following detailed description.

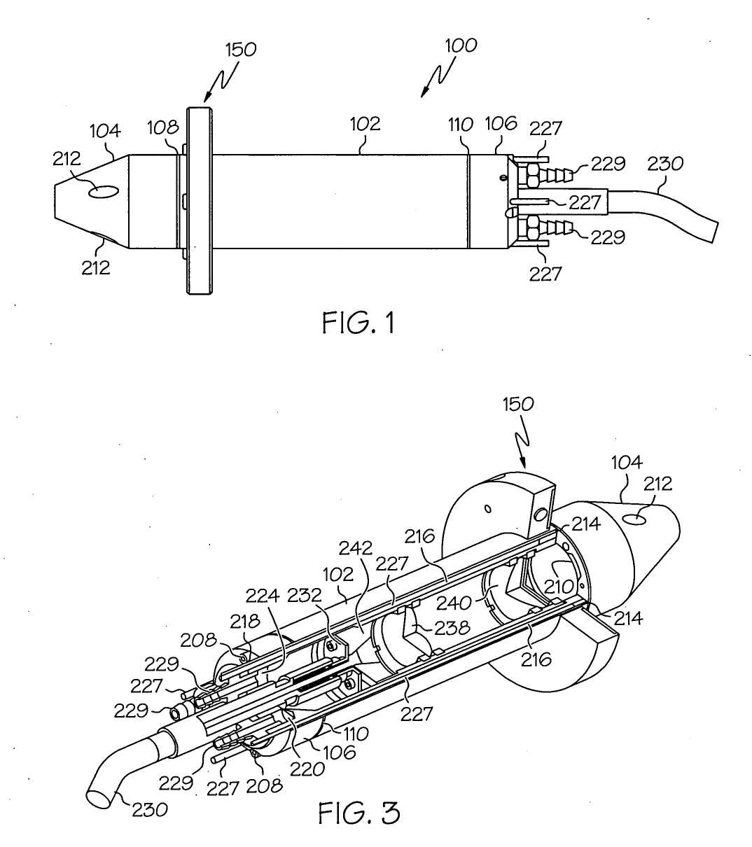

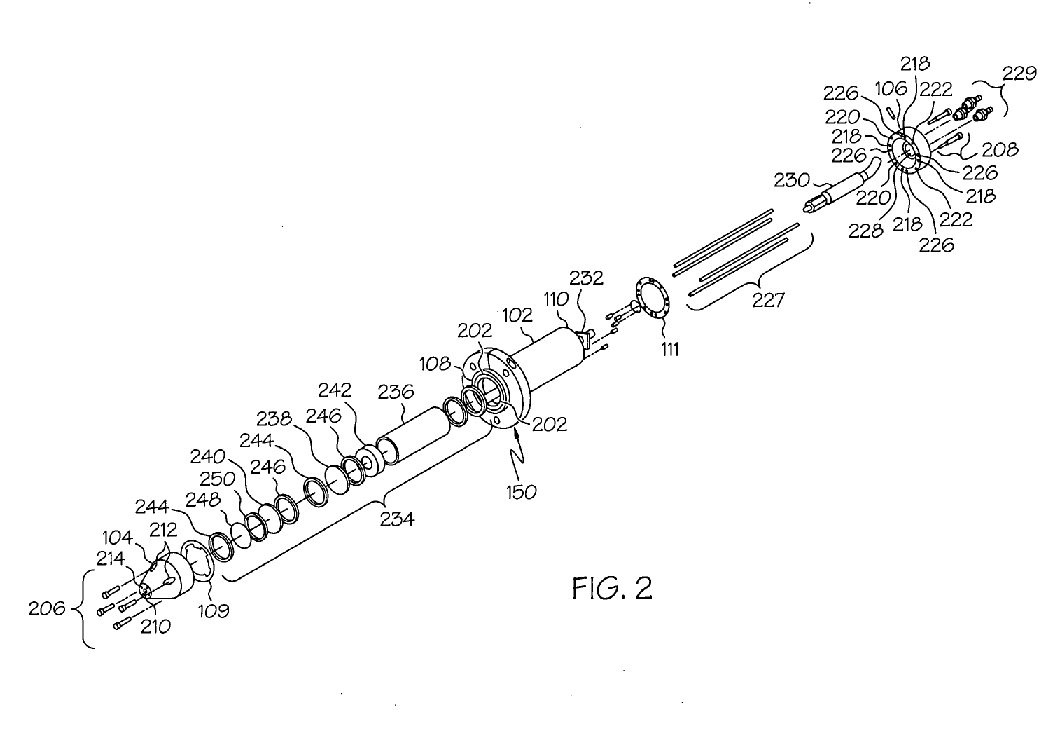

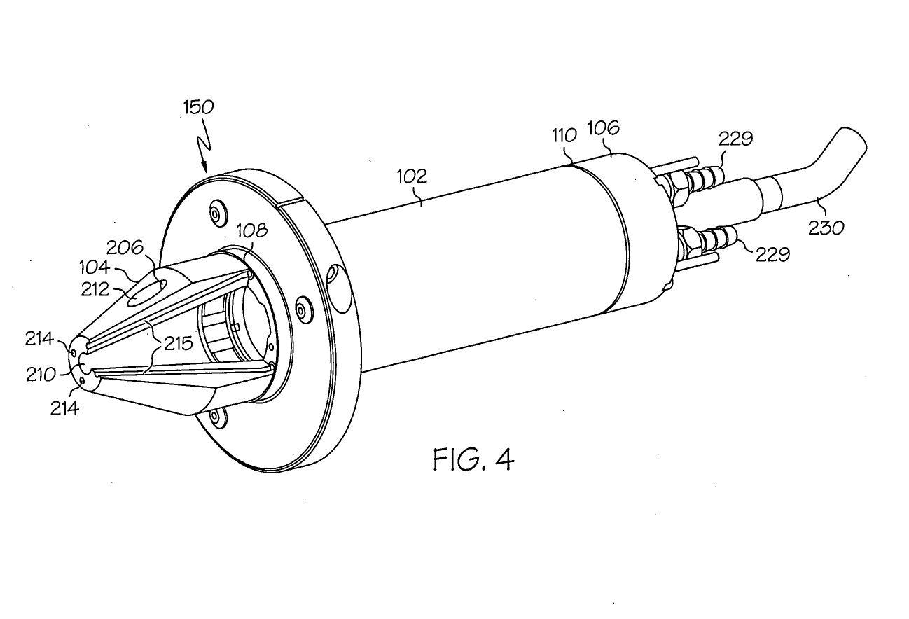

Turning now to the description, and with reference first to FIGS. 1-5, an exemplary hand-held laser welding wand 100 is shown, and includes a main body 102, a nozzle 104, and an end cap 106. The main body 102, which is preferably configured as a hollow tube, includes a first end 108 and a second end 110. As shown in FIGS. 2-5, the main body first 108 and second 110 ends each include a plurality of threaded openings 202 and 204, respectively. The threaded openings 202 in the main body first end 108 each receive a nozzle fastener 206 having mating threads, and which are used to couple the nozzle 104 to the main body first end 108 via a first gasket 109. Similarly, the threaded openings 204 in the main body second end 110 each receive a cap end fastener 208 that has mating threads, and which are used to couple the end cap 106 to the main body second end 110 via a second gasket 111. It will be appreciated that the nozzle 104 and end cap 106 could be coupled to the main body first 108 and second 110 ends, respectively, in a different manner. For example, one or both of the nozzle 104 and interface section 106 could be threaded onto the main body first 108 and second 110 ends, respectively. Moreover, it will be appreciated that the main body 102, and/or the nozzle 104, and/or the end cap 106 could be integrally formed.

The main body 102 additionally includes a plurality of orifices and flow passages that extend between the main body first 108 and second ends 110. These orifices and flow passages are used to direct various fluids and other media through the main body 102 and to the nozzle 104. Included among these media are coolant, such as water, inert gas, such as Argon, and filler materials, such as powder, wire, or liquid. These orifices and flow paths are in fluid communication with orifices and flow paths in both the nozzle 104 and the end cap 106. A description of the specific configuration of each of the orifices and flow paths in the main body 102 is not needed. Thus, at least the coolant and gas orifices and flow passages in the main body 102 will not be further described. The main body filler media orifices and flow paths will be mentioned further below merely for completeness of description.

The nozzle 104, as was noted above, is coupled to the main body first end 108, and includes an aperture 210 that extends through the nozzle 104 and fluidly communicates with inside of the hollow main body 102. The nozzle 104 additionally includes a plurality of fastener openings 212, and a plurality of filler media openings 214. The nozzle fastener openings 212 extend through the nozzle 104 and one of the nozzle fasteners 206 passes through each of the nozzle fastener openings 212 and into the main body first end 108, as described above. The nozzle filler media openings 214 also pass through the nozzle 104. The nozzle filler media openings 214 are in fluid communication with filler media delivery flow paths 216 that extend through the main body 102, and are used to deliver a filler media to a work piece (not shown).

The end cap 106, as was noted above, is coupled to the main body second end 110 via the plurality of end cap fasteners 208. In particular, the end cap fasteners 208 extend, one each, through a plurality of end cap fastener openings 218 formed through the end cap 106, and into the main body second end 110. In addition to the end cap fastener openings 218, the end cap 106 also includes two coolant openings 220, 222, a gas supply opening 224, a plurality of filler media openings 226, and a cable opening 228. The two coolant openings include a coolant supply opening 220 and a coolant return opening 222. The coolant supply opening 220 directs coolant, such as water, into appropriate coolant flow passages formed in the main body 102. The coolant return opening 222 receives coolant returned from appropriate coolant flow passages formed in the main body 102. The gas supply opening 224 directs an inert gas into appropriate gas flow passages formed in the main body 102. A barbed fitting 229 is preferably coupled to each of the coolant supply 220, coolant return 222, and gas supply 224 openings. These barbed fittings 229 may be used to couple the openings 220-224 to hoses or other flexible conduits (not shown) that are in fluid communication with a coolant source or a gas source (not shown), as may be appropriate.

The end cap filler media openings 226 are in fluid communication with the nozzle filler media openings 214, via filler media flow paths 215 formed in the nozzle and the main body filler media flow paths 216. The end cap filler media openings 226 may be coupled to receive any one of numerous types of filler media including, but not limited to, those delineated above. The filler media may be fed into the end cap filler media openings 226 manually, or the filler media may be fed automatically from a filler media feed assembly (not shown). In the depicted embodiment, a plurality of filler media liner tubes 227 is provided. These filler media liner tubes 227 may be inserted, one each, into one of the end cap filler media openings 226, and into the main body filler media flow paths 216. The filler media liner tubes 227 further guide the filler media into and through the main body 102, and into the nozzle filler media flow paths 215. The filler media liner tubes 227 also protect the filler media openings against any erosion that could result from filler media flow through the openings and flow passages. Although use of the filler media liner tubes 227 is preferred, it will be appreciated that the wand 100 could be used without the filler media liner tubes 227.

The cable opening 228 in the end cap 106 is adapted to receive an optical cable 230. When the optical cable 230 is inserted into the cable opening 228, it extends through the end cap 106 and is coupled to a cable receptacle 232 mounted within the main body 102. The optical cable 230 is used to transmit laser light from a laser source (not shown) into the main body 102. An optics assembly 234 is mounted within the main body 102 and is used to appropriately collimate and focus the laser light transmitted through the optical cable 230 and receptacle 232, such that the laser light passes through the nozzle aperture 210 and is focused on a point in front of the nozzle aperture 210. A brief description of an embodiment of the optics assembly 234 will now be provided.

The optics assembly 234 includes a lens tube 236, a first lens 238, a second lens 240, and an optical adjustment screw 242. The lens tube 236 is preferably constructed of, or coated with, a material that is optically inert. For example, in the depicted embodiment, the lens tube 236 is constructed of black anodized aluminum. The first 238 and second 240 lenses are each mounted within the lens tube 236 via appropriate mounting hardware. In particular, each of the lenses 238, 240 is mounted between first and second retaining rings 244, 246. In addition, a lens cover 248 and lens cover spacer 250 are disposed in front of the second lens 240, providing physical protection for the second lens 240.

With the above described configuration, laser light transmitted through the optical cable 230 and receptacle 232 passes through the first lens 238, which refracts the laser light so that it travels substantially parallel to the interior surface of the lens tube 236. The parallel laser light then passes through the second lens 240, which focuses the laser light to a point in front of the nozzle aperture 210. It will be appreciated that the location of point in front of the nozzle aperture 210 to which the laser light is focused is a function of the focal length of the second lens 240, and its mounting location within the lens tube 236, which is determined by the second lens' retaining rings 244, 246. It will additionally be appreciated that the spacing of the first lens 238 relative to the optical receptacle 232 affects the collimation of the optics assembly 234. Hence, the optical adjustment screw 242 is movably mounted within the lens tube 236, and may be used to adjust the spacing between the first 238 and the optical receptacle 232. In a particular preferred embodiment, the inner surface of the lens tube 236 and the outer surface of the optical adjustment screw 242 are each threaded to provide this adjustability function.

The laser light transmitted through the nozzle aperture 210 is used to conduct various types of welding processes on various types, shapes, and configurations of work pieces. Thus, as was previously noted, some of the laser light will be reflected off the work piece back toward the wand 100, and thus back toward the hand of a user holding the wand 100. This reflected laser light, which may include both a diffuse component and a specular component, is reflected away from the wand 100 via a reflection shield 150, which is mounted on the wand main body 102. Although the reflection shield 150 is shown mounted on the wand main body 102 near the main body first end 108, it will be appreciated that it may be mounted at any one of numerous positions along the wand main body 102. Moreover, while the depicted reflections shield 150 is preferably configured to mount on the wand main body 102, it will be appreciated that the reflection shield 150 could also be configured to mount on the nozzle 104. A detailed description of a particular preferred embodiment of the reflection shield 150 will now be provided.

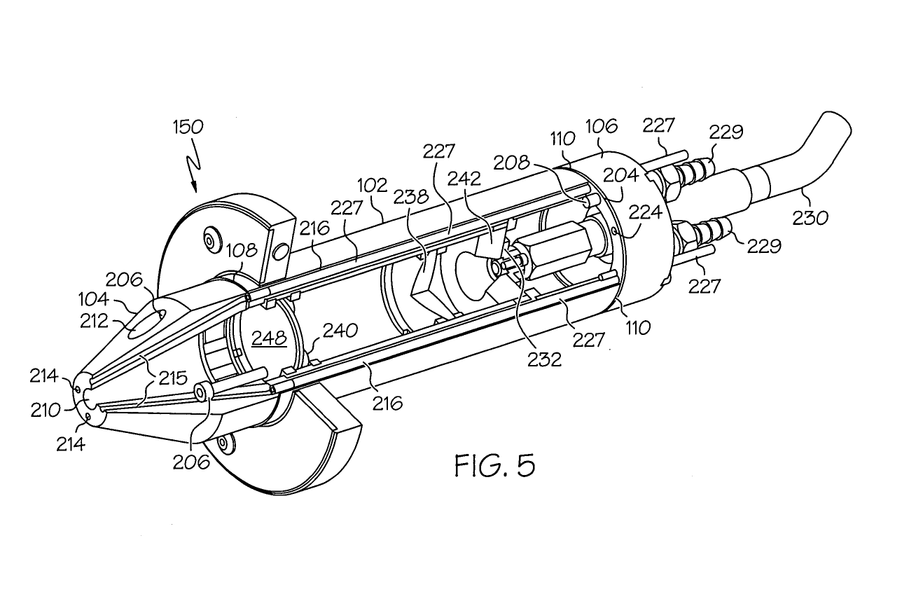

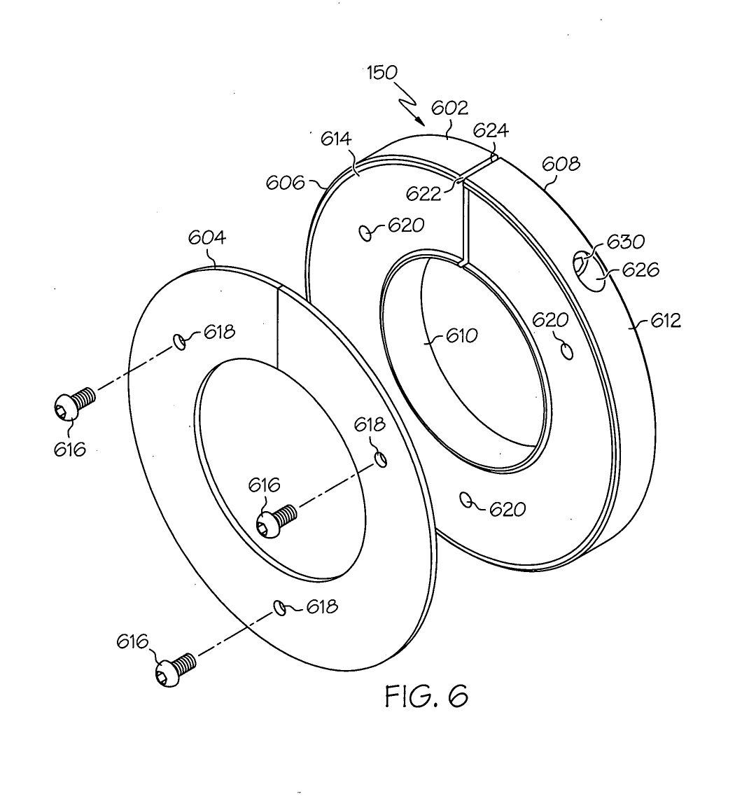

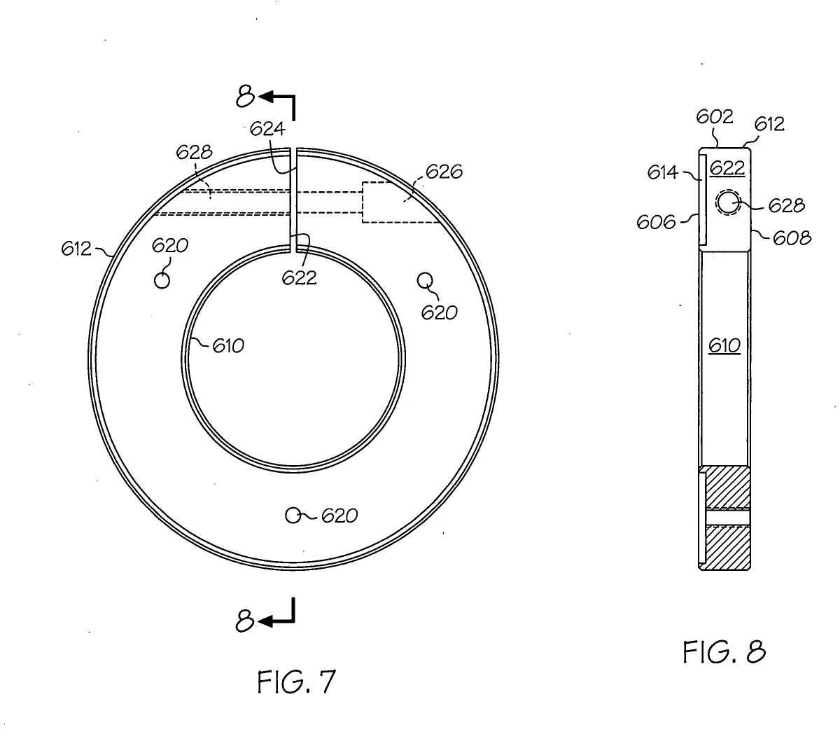

With reference to FIGS. 6-8, it is seen that the reflection shield 150 includes a clamp 602 and a shield 604. In the depicted embodiment, the clamp is configured as an annulus having a front side 606, a back side 608, an inner peripheral surface 610 and an outer peripheral surface 612. The clamp 602 may be formed of any one of numerous materials, both metallic and non-metallic, but in a particular preferred embodiment is formed of red anodized aluminum. As is shown most clearly in FIGS. 6 and 8, a recess 614 is preferably formed in the clamp front face 606. The recess 614 is preferably dimensioned so that the shield 604, when coupled to the clamp 602, fits flush within the recess 614. It will be appreciated that the clamp 602 may be formed into a variety of shapes, not just the exemplary annular ring shape shown in FIGS. 6-8. The particular shape may vary to accommodate varying work piece geometries and configurations. Thus, the clamp 602 may be selected from a plurality of clamps 602, depending on the particular work piece geometry or configuration. It will additionally be appreciated that, in one embodiment, the clamp outer peripheral surface 612 is elliptically shaped. With an elliptical outer peripheral surface 612, the reflection shield 150 may be rotated to varying positions to optimize the amount of reflected laser light the reflection shield 150 intercepts.

In the depicted embodiment, the shield 604 is coupled to the clamp front side 606 using a plurality of threaded fasteners 616. As such, the shield 604 and clamp 602 each include a plurality of openings 618 and 620, respectively, to receive the threaded fasteners 616. Thus, similar to the clamp 602, this allows the shield 604 to be selected from a plurality of shields 604, depending on the particular type of laser being used to perform the laser welding process. This also allows the shield 604 to be selectively removed from the clamp 602. It will be appreciated that the use of threaded fasteners is merely exemplary of one method of coupling the shield 604 to the clamp 602.

Similar to the clamp 602, the shield 604 may also be formed into a variety of shapes to thereby accommodate various geometries that different work pieces may present. In the depicted embodiment, the shield 604 is formed as a substantially flat, uniformly thick shield that is split in a manner similar to the clamp 602, as will be described below. However, to accommodate varying geometries, the shield 604 could be configured to be non-flat, and/or non-uniformly thick, to accommodate various work piece geometries. The shield 604 may additionally be constructed of any one of numerous materials that are substantially impervious to laser light and thermal radiation. The particular material may vary, as was noted above, depending upon the characteristics, such as the wavelength, of the laser, and/or the characteristics of the work piece. The shield 604, as was also noted above, may be selected from a plurality of shields 604 that may exhibit different characteristics at different wavelengths. It is additionally noted that the surface finish of the shield 604 is preferably conducive to the generation of diffuse reflections at the wavelength of the laser being employed. This helps to minimize heat build-up in the shield 604, and thus heat transfer to the clamp 602 and wand main body 102.

The reflection shield 150 is preferably configured to be movable along the wand main body 102. This allows the reflection shield 150 to be positioned to provide optimal accessibility and protection for a given situation. To implement this functionality, the clamp 602, in the depicted embodiment, is configured as a split annulus, having a first end surface 622 and a second end surface 624 disposed adjacent one another. A first opening 626 extends between the outer peripheral surface 612 and the second end surface 624, and a collocated second opening 628 extends between the outer peripheral surface 612 and the first end surface 622. The second opening 628 is preferably threaded and receives a threaded fastener 630 that extends through the first opening 626, and that is used to tighten the clamp 602 onto the wand main body 102 once the clamp 602 has been placed at its desired position. It will be appreciated that this configuration is merely one particular preferred configuration that may be used to implement this functionality. One non-limiting alternative example includes a separate hose clamp-type configuration that is held together by either a threaded fastener or spring tension.

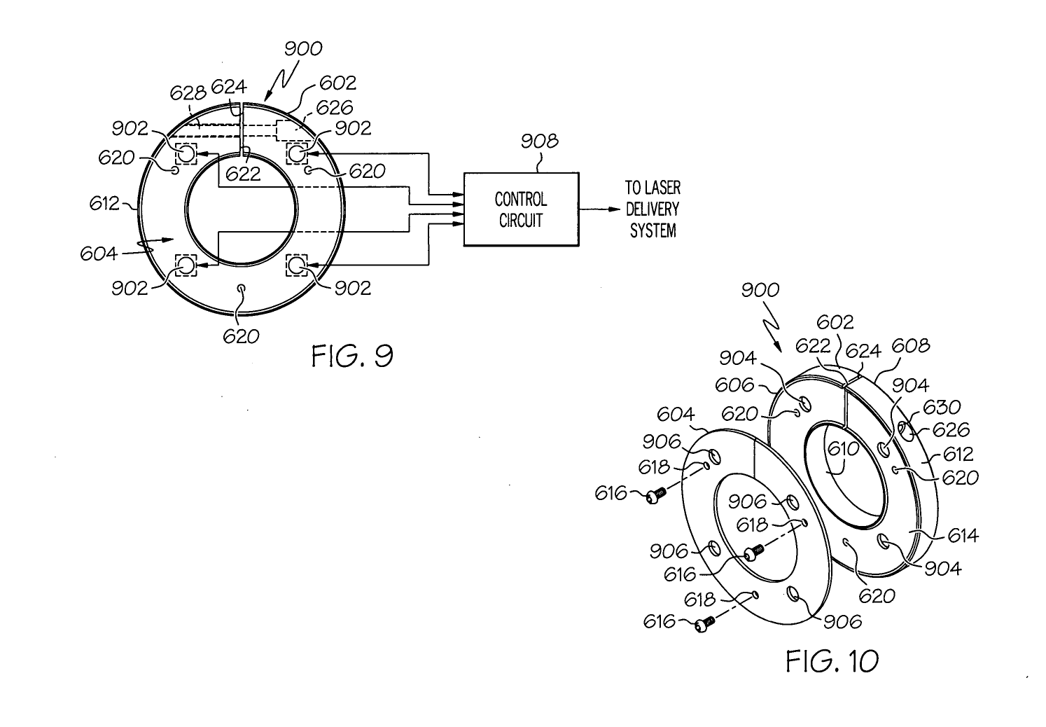

In certain instances, it may be desirable to inhibit operation of the laser welding wand 100 until the wand 100 is appropriately configured relative to the surface of a workpiece. Although this functionality may be implemented in any one of numerous ways, one particular preferred implementation is depicted in FIGS. 9 and 10, which depicts an alternative reflection shield embodiment, and in which like reference numerals refer to like parts of the previously described embodiment. As FIGS. 9 and 10 show, the depicted alternative laser reflection shield 900 is constructed similar to the previously described embodiment, in that it includes a clamp 602 and a shield 604. However, this alternative embodiment 900 additionally includes one or more proximity sensors 902. In the depicted embodiment, four proximity sensors 902 are mounted on the clamp back side 608, and are evenly spaced around the clamp 602.

The proximity sensors 902 may be any one of numerous types of sensors, including both contact-type and non-contact-type, but in the depicted embodiment, the proximity sensors 902 are each ultrasonic sensors. Moreover, to enhance the sensitivity of the proximity sensors 902, the clamp 602 and shield 604, as shown most clearly in FIG. 10, each include a plurality of sensor apertures 904 and 906, respectively. Each of the sensors 902 is mounted on the clamp back side 608 proximate one of the clamp sensor apertures 904, and the shield 604 is mounted on the clamp 602 so that the shield sensor apertures 906 each align with one of the clamp sensor apertures 904.

The proximity sensors 902, as also depicted in FIG. 9, are preferably coupled to a control circuit 908, which may in turn be coupled to the laser delivery system (not shown) that is coupled to the laser welding wand 100. The control circuit 908 receives signals from the proximity sensors 902 that are representative of the proximity of the laser welding wand 100 to a workpiece. The control circuit 908 is preferably configured, in response to the received signals, to either allow or prevent laser light delivery from the laser delivery system to the laser welding wand 100.

With the reflection shield 150 installed and appropriately positioned on the laser welding wand 100, laser light directed onto a work piece from the wand 100, and reflected off the work piece will be intercepted and deflected away from an operator using the wand 100 by the reflection shield 150. This will help guard against a user of the wand 100 absorbing laser light that may be reflected off a work piece, as well as significantly reduce any heat that might be transferred to the wand 100 as a result of the reflected laser light.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A hand-held laser fusion welding assembly for treating a workpiece, comprising:
a main body dimensioned to be grasped by a hand and adapted to couple to at least a laser delivery system;
a nozzle coupled to the main body and having an aperture through which laser light from the laser delivery system may pass; and
a laser reflection shield coupled to, and at least partially surrounding, either the nozzle or the main body, the laser reflection shield constructed at least partially of a material that reflects at least a portion of the laser light that passes through the nozzle aperture and is reflected by the workpiece.

2. The assembly of claim 1, wherein the laser reflection shield is configured to be movable on, and removable from, the main body and nozzle.

3. The assembly of claim 1, wherein:
the reflected laser light is characterized by at least a wavelength; and
the material of which the laser reflection shield is at least partially constructed has low absorption characteristics at the reflected laser light wavelength.

4. The assembly of claim 1, wherein the laser reflection shield is configured and constructed to diffusely reflect the laser light reflected by the workpiece.

5. The assembly of claim 1, wherein the laser reflection shield comprises:
a clamp having at least a front side and a back side; and
a shield plate coupled to clamp front side.

6. The assembly of claim 5, further comprising:
a plurality of clamps from which the clamp is selected; and
a plurality of shield plates from which the shield plate that is coupled to the clamp front side is selected.

7. The assembly of claim 5, wherein:
the clamp front side has a recess formed therein; and
the shield plate is disposed at least partially within the recess.

8. The assembly of claim 5, wherein the clamp is an annulus having an inner peripheral surface and an outer peripheral surface, each peripheral surface disposed between the clamp front and back sides.

9. The assembly of claim 8, wherein the annulus includes a first end and a second disposed adjacent one another, and wherein the clamp further comprises:
an adjustable fastener coupled to the clamp, the adjustable fastener configured to move the first and second ends relative to one another.

10. The assembly of claim 9, wherein the adjustable fastener comprises a threaded fastener that extends through the annulus outer peripheral surface, through the annulus first end, and at least partially into the second end.

11. The assembly of claim 5, further comprising:
a plurality of threaded openings formed in the clamp front side;
a plurality of openings extending through the shield plate, each shield plate opening collocated with one of the threaded openings; and
a plurality of threaded fasteners, each fastener extending through one of the shield plate openings and into one of the threaded openings.

12. The assembly of claim 1, further comprising:
one or more proximity sensors coupled to the laser reflection shield, each proximity sensor configured to sense a proximity of the laser reflection shield to the workpiece and operable, in response thereto, to supply proximity signals representative thereof.

13. The assembly of claim 12, further comprising:
one or more sensor apertures formed through the reflection shield,
wherein each proximity sensor is mounted proximate one of the reflections shield sensor apertures.

14. The assembly of claim 12, further comprising:
a control circuit coupled between each proximity sensor and the laser delivery system, the control circuit coupled to receive proximity signals and operable, in response thereto, to selectively allow or prevent laser light delivery from the laser delivery system.

15. A laser reflection shield for reflecting laser light, comprising:
a clamp adapted to mount on a hand-held laser welding wand, the clamp having at least a front side and a back side; and
a shield plate coupled to the clamp front side, the shield plate constructed at least partially of a material that reflects at least a portion of the laser light.

16. The shield of claim 15, wherein:
the laser light is characterized by at least a wavelength; and
the material of which the shield plate is at least partially constructed has low absorption characteristics at the laser light wavelength.

17. The shield of claim 15, wherein the shield plate is configured and constructed to diffusely reflect the laser light.

18. The shield of claim 15, further comprising:
a plurality of clamps from which the clamp is selected; and
a plurality of shield plates from which the shield plate that is coupled to the clamp front side is selected.

19. The shield of claim 15, wherein:
the clamp front side has a recess formed therein; and
the shield plate is disposed at least partially within the recess.

20. The shield of claim 19, wherein the clamp is an annulus having an inner peripheral surface and an outer peripheral surface, each peripheral surface disposed between the clamp front and back sides.

21. The shield of claim 20, wherein the annulus includes a first end and a second end disposed adjacent one another, and wherein the clamp further comprises:
an adjustable fastener coupled to the clamp, the adjustable fastener configured to move the first and second ends relative to one another.

22. The shield of claim 21, wherein the adjustable fastener comprises a threaded fastener that extends through the annulus outer peripheral surface, through the annulus first end, and at least partially into the second end.

23. The shield of claim 15, further comprising:
a plurality of threaded openings formed in the clamp front side;
a plurality of openings extending through the shield plate, each shield plate opening collocated with one of the threaded openings; and
a plurality of threaded fasteners, each fastener extending through one of the shield plate openings and into one of the threaded openings.

24. The shield of claim 15, further comprising:
one or more proximity sensors coupled to the laser reflection shield, each proximity sensor configured to sense a proximity of the laser reflection shield to a workpiece and operable, in response thereto, to supply proximity signals representative thereof.

25. The shield of claim 24, further comprising:
one or more sensor apertures formed through the reflection shield, wherein each proximity sensor is mounted proximate one of the reflections shield sensor apertures.
